(19) United States
(12) Patent Application Publication
(10) Pub. No.: US 2012/0141855 A1
(43) Pub. Date: Jun. 7, 2012

(54) BATTERY PACK FOR SUPPRESSING DEVIATION OF CENTRAL BATTERY CELL AND VEHICLE INCLUDING THE SAME

(76) Inventors: Wataru Okada, Kobe-shi (JP); Shinsuke Nakamura, Kobe-shi (JP); Tomoyuki Ohmura, Kakogawa-shi (JP); Akinobu Wakabayashi, Kobe-shi (JP)

(21) Appl. No.: 13/309,004

(22) Filed: Dec. 1, 2011

(30) Foreign Application Priority Data
Dec. 4, 2010 (JP) 2010-270978

(51) Int. Cl. H01M 2/10

(52) U.S. Cl. 429/99

(57) ABSTRACT

A battery pack device includes a plurality of battery cells 1, a bind bar 4, and a regulation member 31. The plurality of battery cells 1 has a rectangular box exterior shape. The bind bar 4 couples the plurality of battery cells 1 to each other with the battery cells 1 being arranged side by side. When the battery pack 10 is secured onto a horizontal surface, the regulation member 31 regulates upward deviation of at least one of the battery cells 1, which is located in a central part of the battery pack in the side-by-side arrangement direction of the battery cells 1.

### BACKGROUND OF THE INVENTION

1. Field of the Invention

The present invention relates to a battery pack including a plurality of rectangular-box-shaped battery cells, and in particular to a battery pack to be used as a power supply device for electric motors for driving vehicles such as hybrid cars and electric vehicles. In addition, the present invention relates to an electrically-driven vehicle including this battery pack.

2. Description of the Related Art

Electric vehicles and hybrid cars are known. Electric vehicles are driven by an electric motor. Hybrid cars are driven by an electric motor and an internal-combustion engine. These types of cars include a power supply device which includes battery cells accommodated in an exterior case. In order to provide enough power to drive the cars by means of an electric motor, such a power supply device includes a number of battery cells serially connected to each other for increasing output voltage. For example, a battery pack is constructed of battery cells which have a rectangular box exterior container and are arranged side by side. The power supply device is constructed of a plurality of thus-constructed battery packs which are connected to each other.

See Japanese Patent Laid-Open Publication Nos. JP 2008-282582 A and JP 2010-110833 A, for example.

Each of the battery cells includes positive/negative electrode terminals which protrude from the battery cell upper surface. The electrode terminals of each battery cell are secured to a sealing plate. A number of thus-constructed battery cells are arranged side by side with electrically-insulating separators being interposed between the battery cells adjacent to each other. End plates are arranged on the end surfaces of the battery cells which are arranged on the outermost sides. Thus, the battery pack is assembled. In addition, the end plates are coupled to each other by metal bind bars so that the battery cells are held in the side-by-side arrangement. In the case where the end plates are coupled to each other by the metal bind bars, the metal bind bars are required to have enough strength to stably hold the battery cells for a long time. Particularly, in the case where the battery pack is used for vehicles, the battery pack will be subjected to vibration and shock. For this reason, it is required to more securely hold the battery cells.

It is difficult for the thus-constructed battery pack to reliably prevent vertical vibration of the battery cells which are held side by side by the bind bars. Particularly, in the case where the battery pack is used in a vibration environment such as vehicle environment, it is hard to reliably prevent the vibration of the battery cells. In the case where the battery pack includes a number of battery cells which are arranged side by side with the separators being interposed between the battery cells adjacent to each other, when the battery pack is disposed in a vibration environment, vertical force is applied to the battery cells. As a result, some of the battery cells are vibrated which are located in the central part. If the central battery cells are thus vibrated, various defects may occur. For example, if a battery cell is vibrated, an electrically-insulating layer arranged on the surface of the battery cell will rub against the bind bars which are not vibrated. As a result, the electrically-insulating layer may be damaged, which in turn causes puncture or short circuit. In addition, vibration may physically damage the battery cells, and may deteriorate the electrical characteristics of the battery cells or reduce battery cell life. Thus, vibration may cause these defects. Particularly, in the case of vehicle power supply device, vibration and shock may cause vertical deviation of battery cells over the course of use. The electrode terminals on the upper surface of battery cells are connected to each other by bus bars. If the central battery cells are deviated upward, a stress will be applied to a connection part between the electrode terminal and the sealing plate, which may cause cracks or rupture. Since the contact resistance will increase in the connection part between the electrode terminal and the bus bar, electrical characteristic deterioration, part deformation and deterioration caused by generated heat, and the like are also concerned.

The present invention is aimed at solving the problems. It is a main object to provide a reliability-improved battery pack that has a simple structure but can suppress vertical movement of battery cells whereby preventing various defects caused by the vertical movement of battery cells, and an electrically-driven vehicle including this battery pack.

### SUMMARY OF THE INVENTION

To achieve the above object, a battery pack device according to a first aspect of the present invention includes a plurality of battery cells 1, a bind bar 4 or 47, and a regulation member 31, 41, 51, 61, 71 or 81. The plurality of battery cells 1 have a rectangular box exterior shape. The bind bar 4 or 47 couples the plurality of battery cells 1 to each other with the battery cells 1 being arranged side by side. When the battery pack 10 or 70 is secured onto a horizontal surface, the regulation member 31, 41, 51, 61, 71 or 81 regulates upward deviation of at least one battery cell of the battery cells 1 which is located in a central part of the battery pack in the side-by-side arrangement direction of the battery cells 1.

Note that “the battery pack is secured onto a horizontal surface” is used in a broad sense in this specification to include that the battery pack is secured onto a surface which is slightly inclined from the horizontal plane.

In addition, “at least one of the battery cells, which is located in a central part of the battery pack in the side-by-side arrangement direction of the battery cells” is referred in this specification to as at least one of battery cells which are located at positions except the end positions of the side-by-side arrangement.

According to the thus-constructed battery pack, when the battery pack is secured onto a horizontal surface, it is possible to prevent vertical deviation of the at least one of the battery cells, which is located in a central part of the battery pack. Accordingly, the plurality of battery cells can be held coplanar. Therefore, it is possible to keep the coupled state of the battery cells, and to improve reliability.

In a battery pack according to a second aspect of the present invention, the regulation member 31, 41, 71 or 81 can be a biasing member which is opposed to the at least one battery cell 1, which is located in the central part, and contacts the upper surface of the battery pack 10 or 70.

According to this construction, the battery pack is biased from the upper surface side. Therefore, it is possible to effectively prevent that battery cells are deviated upward.

In a battery pack according to a third aspect of the present invention, the regulation member 31 or 41 can be a bracket 33 or 43 which is secured to the bind bar 4. The bracket 33 or 43 has a horizontal portion 33A or 43A extending along the upper surface of the battery pack 10. The horizontal portion 33A or 43A contacts the upper surface of the battery pack 10.

According to the thus-constructed battery pack, since the upper surface of the battery pack contacts the horizontal portion, which is arranged in the bracket secured to the bind bar, this bracket biases the central part of the battery pack. Therefore, it is possible to effectively prevent that this part is deviated upward.

In a battery pack according to a fourth aspect of the present invention, the bind bar 4 can include a plurality of regulation members 31 or 41 as the regulation member.

According to this construction, two or more battery cells which are located in the central part can be held at a plurality positions. Therefore, it is possible to surely prevent deviation of the two or more battery cells. In particular, among battery cells which are located in the central part, two or more battery cells can be selectively held which are likely to be deviated upward.

In a battery pack according to a fifth aspect of the present invention, bind bars 4 as the bind bar can be arranged on the both side surfaces of the battery pack 10. The numbers of the plurality of regulation members 31 or 41 are different from each other which are included in the bind bars 4, which are located on the side surfaces.

According to this construction, since it is not required to commonly construct bind bars, it is possible to flexibly select and arrange bind bars depending on arrangement of battery cells and available space.

In a battery pack according to a sixth aspect of the present invention, the bind bar 74 can be arranged on a side surface of the battery pack 70. The upper end part of the bind bar 74 is bent so that a horizontal portion 74y is formed extending along the upper surface of the battery pack 70. This horizontal portion 74y serves as the regulation member 71 to contact the upper surface of the battery pack 70.

According to the thus-constructed battery pack, since the bind bar is arranged on a side surface of the battery pack with a bent horizontal portion as the regulation member being formed by bending the upper end part of the bind bar and contacting the upper surface of the battery pack, the central battery cell can be surely held by the bind bar. Therefore, the central battery cell can be relatively less likely to vibrate. Also, according to this construction, since the bind bar includes the bent horizontal portion, the vertical and horizontal bending strength of the bind bar can be improved. Therefore, this bind bar can firmly couple the plurality of battery cells to each other in the side by side arrangement.

A battery pack according to a seventh aspect of the present invention can further include a top cover 6A, and sealing member 8. The top cover 6A covers the upper surface of the battery pack. The sealing member 8 is sandwiched between the top cover 6A and the battery pack 10. The regulation member 81 can be a thicker portion 8A of the sealing member 8 that is located in the central part and formed thicker than other parts of the sealing member.

According to this construction, since the central part of the battery pack is strongly biased from the upper surface side, it is possible to effectively prevent upward deviation of battery cells which are located in the central part.

In a battery pack according to an eighth aspect of the present invention, the thicker portion 8A can be formed of a urethane sheet.

According to this construction, the deterioration of the thicker portion can be suppressed even under high temperature conditions. Therefore, it is possible to provide highly reliable regulation effects.

In a battery pack according to a ninth aspect of the present invention can further include a plurality of electrically-insulating separators 2 that are interposed between the battery cells 1 adjacent to each other. The separators 2 cover at least parts of upper surfaces of the battery cells 1 and also serve as cover portions 23. The regulation member 31, 41, 71 or 81 contacts the upper surfaces of the cover portions 23.

According to this construction, since the regulation member does not directly bias the battery cell but biases the electrically-insulating separator, a metal regulation member can be used. Therefore, it is possible to improve the mechanical strength, and to improve the reliability.

In a battery pack according to a tenth aspect of the present invention can further include a base plate 6X that is located under the lower surface of the battery pack 10. The battery pack 10 is secured onto this base plate. The regulation member 51 is a securing member 53 that fastens the bind bar 4 to the base plate 6X.

According to this construction, when the lower surface of the battery pack is secured onto a horizontal surface, it is possible to effectively prevent upward deviation of battery cells which are located in the central part.

In a battery pack according to an eleventh aspect of the present invention can further include a base plate 6X that is located under the lower surface of the battery pack 10. The battery pack is secured onto this base plate. The regulation member 61 is a securing member 63 that fastens the central part of the battery pack 10 to the base plate 6X. The lower end part of the securing member 63 is secured to the base plate 6X. The securing member has a horizontal portion 63A on the upper end. The securing member extends along the upper surface of the battery pack 10. The horizontal portion 63A contacts the upper surface of the battery pack 10.

According to this construction, since the upper surface of the central part of the battery pack is coupled to the base plate, it is possible to surely prevent upward deviation of battery cells which are located in the central part.

In a battery pack according to a twelfth aspect of the present invention can further include a plurality of electrically-insulating separators 2 that are interposed between the battery cells 1 adjacent to each other. The separator 2 includes protruding portions 25 that protrude outward from the both side surfaces of the battery pack 10 or 70. The protruding portions 25 are arranged extending along the side edges of the bind bar 4 so that the protruding portions 25 suppress vertical deviation of the separator 2 relative to the bind bar 4.

According to this construction, it is possible to effectively prevent upward deviation of the plurality of separators.

In a battery pack according to a thirteenth aspect of the present invention, bind bars 4 as the bind bar can be arranged on a side surface of the battery pack 10, and be spaced away from each other in the vertical direction.

According to this construction, the upper and lower bind bars can surely hold the battery pack.

In a battery pack according to a fourteenth aspect of the present invention, the central parts of the upper and lower bind bars 4 can be coupled to each other by a reinforcing plate 18.

According to this construction, since it is possible to suppress flexure of the bind bar caused by vibration or the like, the bind bar can be stably held.

Therefore, it is possible to suppress positional deviation of the battery cells, which are coupled to each other by the bind bar.

An electrically-driven vehicle according to a fifteenth aspect of the present invention includes the aforementioned battery pack.

The above and further objects of the present invention as well as the features thereof will become more apparent from the following detailed description to be made in conjunction with the accompanying drawings.

### BRIEF DESCRIPTION OF THE DRAWINGS

FIG. 1 is a vertical traverse cross-sectional view showing a power supply device which includes battery packs according to one embodiment of the present invention;

FIG. 2 is a perspective view schematically showing the internal construction of the power supply device shown in FIG. 1;

FIG. 3 is a perspective view showing a battery pack according to the embodiment of the present invention;

FIG. 4 is an exploded perspective view showing the battery pack shown in FIG. 3;

FIG. 5 is a vertical traverse cross-sectional view showing the battery pack shown in FIG. 3;

FIG. 6 is an exploded perspective view showing a battery cells and separators which are arranged side by side;

FIG. 7 is an enlarged perspective view showing the main part of a regulation member of the battery pack shown in FIG. 3;

FIG. 8 is an exploded perspective view showing the battery pack shown in FIG. 7;

FIG. 9 is a vertical traverse cross-sectional view showing a battery pack according to another embodiment of the present invention;

FIG. 10 is an enlarged perspective view showing the main part of a regulation member of the battery pack shown in FIG. 9;

FIG. 11 is an exploded perspective view showing a battery pack according to another embodiment of the present invention;

FIG. 12 is a vertical traverse cross-sectional view showing a battery pack according to another embodiment of the present invention;

FIG. 13 is an enlarged perspective view showing the main part of a regulation member of the battery pack shown in FIG. 12;

FIG. 14 is a vertical traverse cross-sectional view showing a battery pack according to another embodiment of the present invention;

FIG. 15 is an enlarged perspective view showing the main part of a regulation member of the battery pack shown in FIG. 14;

FIG. 16 is a perspective view showing a battery pack according to another embodiment of the present invention;

FIG. 17 is a perspective view showing a battery pack according to still another embodiment of the present invention;

FIG. 18 is a block diagram showing a hybrid car according to one embodiment of the present invention which is driven by an internal-combustion engine and an electric motor; and

FIG. 19 is a block diagram showing an electric vehicle according to another embodiment of the present invention which is driven only by an electric motor.

### DETAILED DESCRIPTION OF THE EMBODIMENT(S)

The following description will describe embodiments according to the present invention with reference to the drawings. It should be appreciated, however, that the embodiments described below are illustrations of a battery pack and an electrically-driven vehicle including this battery pack to give a concrete form to technical ideas of the invention, and a battery pack and an electrically-driven vehicle including this battery pack of the invention are not specifically limited to description below. Furthermore, it should be appreciated that the members shown in claims attached hereto are not specifically limited to members in the embodiments. Members same as or similar to those of this invention are attached with the same designation and the same reference numerals and their description is omitted. In addition, a plurality of structural elements of the present invention may be configured as a single part that serves the purpose of a plurality of elements, on the other hand, a single structural element may be configured as a plurality of parts that serve the purpose of a single element.

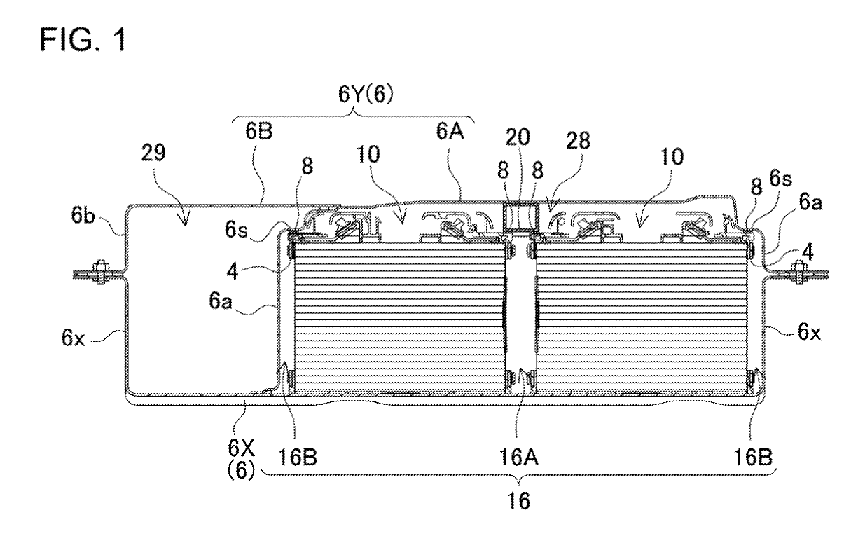

With reference to FIGS. 1 to 6, the following description will describe a power supply device for electrically-driven vehicles to which a battery pack according to an embodiment of the present invention is adopted. The illustrated battery pack is suitable mainly for power supplies of electric vehicles such as hybrid cars which are driven by both an internal-combustion engine and an electric motor, and electric vehicles which are driven only by an electric motor. However, the battery pack according to the present invention can be used for applications other than electric vehicle which require high power.

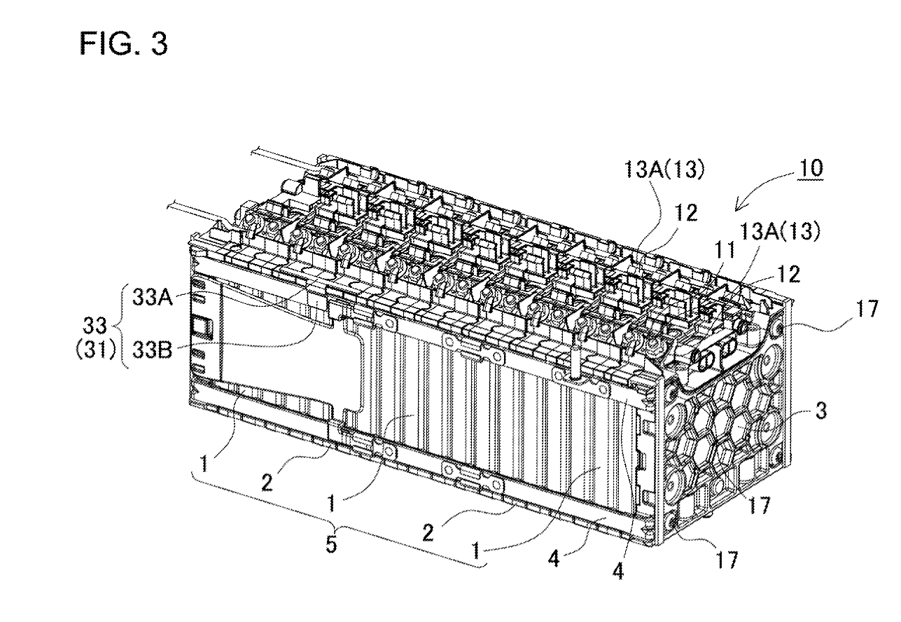

As shown in FIGS. 3 to 6, the battery pack includes a plurality of battery cells 1 and bind bars 4. The battery cells 1 have a rectangular box exterior shape. The bind bar 4 couples the plurality of battery cells 1 to each other with the battery cells 1 being arranged side by side. The illustrated battery pack 10 includes a battery arrangement assembly 5. The battery arrangement assembly 5 is constructed of the plurality of battery cells 1 and electrically-insulating separators 2 which are arranged side by side. The electrically-insulating separators are interposed between the battery cells adjacent to each other. A pair of end plates 3 are arranged on both the end surfaces of this battery assembly 5. The pair of end plates 3 are coupled to each other by the bind bars 4. Thus, the plurality of battery cells 1 are integrally coupled to each other. In the illustrated battery pack 10, ventilation gaps 15 are formed between the separator 2 and the battery cell 1. Air ducts 16 are formed on the both sides of the battery pack 10, which are opposed parts, as shown in FIG. 1. Air is forcedly blown into the ventilation gaps 15 through the air ducts 16. Thus, forcedly-blown cooling air passes through the ventilation gaps 15 from the air ducts 16 so that the battery cells 1 are cooled.

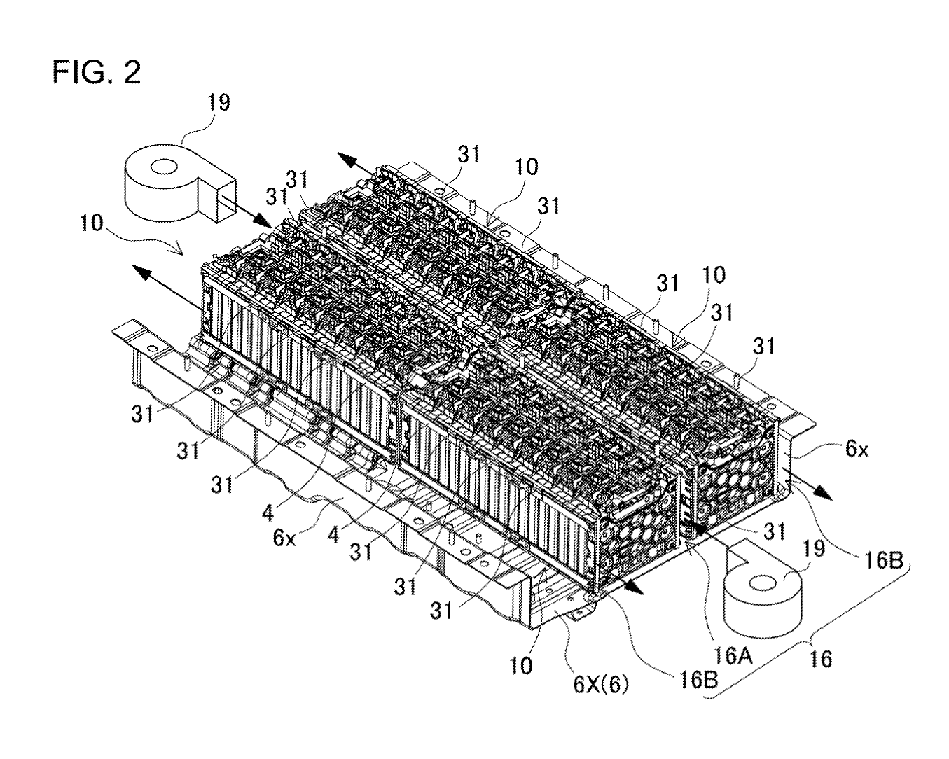

As shown in FIGS. 1 and 2, the battery packs 10 are accommodated in an exterior case 6. Thus, the power supply device is constructed. The exterior case 6 shown in FIG. 1 is constructed of a cover plate 6Y, and a base plate 6X. The cover plate 6Y is secured onto the base plate 6X. The exterior case 6 has a battery accommodating portion 28, and an electronic-component accommodating portion 29. The battery accommodating portion 28 accommodates the battery packs 10. The electronic-component accommodating portion 29 accommodates electronic components (not shown). The cover plate 6Y is composed of a top cover 6A, and an electronic-component cover 6B. The top cover 6A is secured to the base plate 6X so that the battery accommodating portion 28 is formed in the exterior case 6. Also, the electronic-component cover 6B is secured to the base plate 6X and the top cover 6A so that the electronic-component accommodating portion 29 is formed. In addition, after the cover plate 6Y is secured onto a base plate 6X, the openings of the exterior case 6 on both ends are closed by end surface plates (not shown) so that the battery accommodating portion 28 and the electronic-component accommodating portion 29 are formed in the exterior case 6.

In the power supply device of FIGS. 1 and 2, the battery packs 10 are arranged in the two rows in the exterior case 6. The uppers surface of the battery packs 10 are covered by the top cover 6A so that the air ducts 16 are formed between the two rows of the battery packs 10, and on the both sides of two-row battery pack arrangement. A closing member 20 contacts the upper surfaces of the two rows of the battery packs 10. The top cover 6A is secured onto the closing member 20. Sealing members 8 are sandwiched between the top cover 6A and the battery packs 10, and airtightly close the air ducts 16. The sealing members 8 are arranged along the both side edges on upper surfaces of each of the battery packs 10 shown in FIG. 1, in other words, extend in the side-by-side arrangement direction of the battery cell 1. Two of the sealing members 8 are arranged on the inner side edges of the upper surfaces of two rows of the battery packs 10 and are opposed to each other. These two sealing member 8 are biased by the closing member 20 so as to airtightly close the center air duct 16. Other two of the sealing members 8 are arranged on the outer side edges of the upper surfaces of two rows of the battery packs 10. These two sealing member 8 are biased by stepped portions 6s of the top cover 6A so as to airtightly close the outside air ducts 16.

In this power supply device, one of the air ducts as inlet duct 16A is formed between the two rows of battery packs 10, while other two air ducts as outlet ducts 16B are arranged on both the outsides of the battery packs 10. The ventilation gaps 15 are arranged extending parallel to each other between the inlet duct 16A and the outlet ducts 16B. In this power supply device, as shown by arrows in FIG. 2, cooling gas is forcedly blown from the inlet duct 16A toward the outlet ducts 16B by a blower mechanism 19 to cool the battery cells 1. The cooling gas is forcedly blown from the inlet duct 16A toward the outlet ducts 16B, and is then branched from the inlet duct 16A. Thus, the cooling gas flows in the ventilation gaps 15 to cool the battery cells 1. After cooling the battery cells 1, the cooling gas flows merge into the outlet ducts 16B. After that, the merging cooling gas is discharged. Note that, though not illustrated, the inlet ducts can be arranged outsides of the battery packs, while the outlet duct can be arranged between the battery packs so that cooling gas is blown from the outside parts to the center part of the power supply device.

(Battery Cell 1)

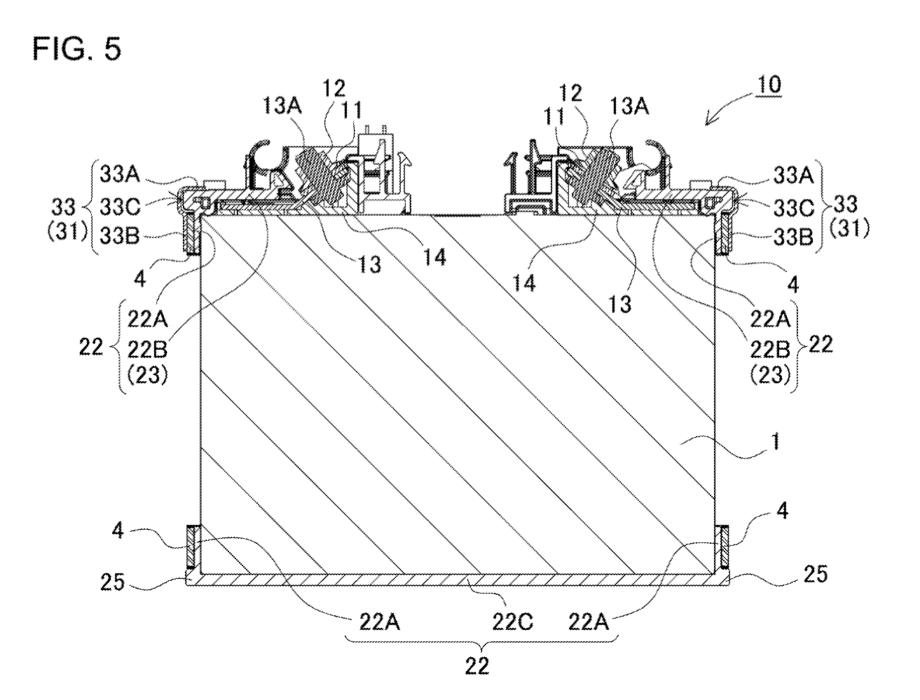

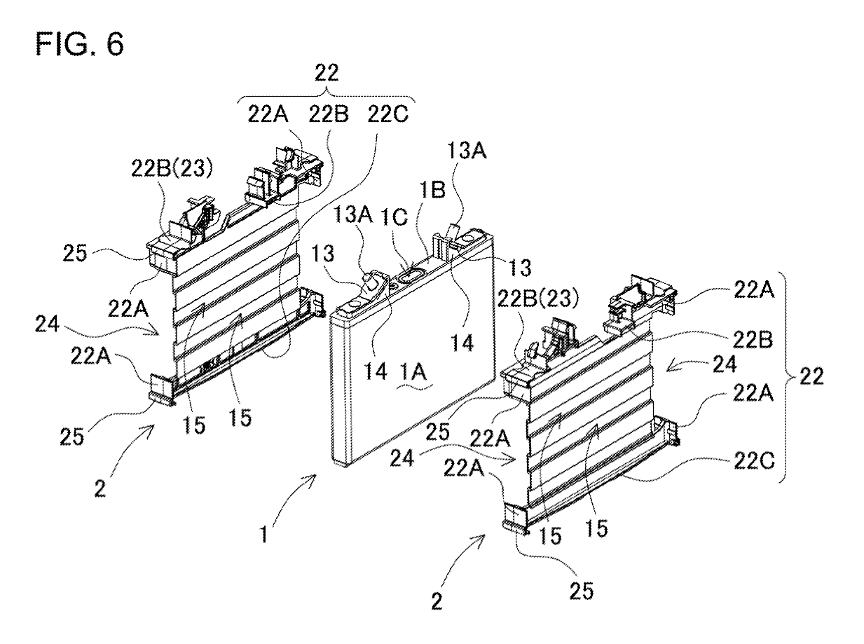

The battery cell 1 is a thin rectangular-box shaped battery the thickness of which is smaller thinner than the width. The battery cells 1 are arranged in parallel to each other. The separator 2 is interposed between the battery cells 1 adjacent to each other. Since the separators 2 electrically insulate the battery cells 1 from each other, the battery cells 1 can be arranged side by side. The positive/negative electrode terminals 13 are secured to and protrude from the both side parts of upper surface of the battery cell 1, as shown in FIG. 5 and FIG. 6. The positive/negative electrode terminals 13 protrude from symmetrical positions with respect to a line. According to this construction, in the case where the battery cells 1 are arranged side by side with being flipped from side to side, the positive and negative terminals 13 of one of the battery cells are serially connected to the negative and positive terminals 13 of another battery cell adjacent to the one of the battery cells by metal plate bus bars 11. Alternatively, the positive and negative terminals 13 of one of the battery cells can be directly serially connected to the negative and positive terminals 13 of another battery cell adjacent to the one of the battery cells. In the case of the battery pack 10 in which the battery cells 1 are serially connected to each other, the output voltage of the battery pack can be high, and as a result the battery pack can provide high power. Note that, in the battery pack according to the present invention, battery cells adjacent to each other may be connected both in parallel and serial to each other.

The battery cell 1 is a lithium-ion rechargeable battery. However, the rectangular-box-shaped battery is not limited to a lithium-ion rechargeable battery. Any rechargeable batteries (e.g., nickel metal hydride batteries) can be also used. The rectangular-box-shaped battery includes electrode members of laminated positive/negative electrode plates. After the electrode members are accommodated in an exterior container 1A, the exterior container 1A is airtightly sealed. The exterior container 1A is formed of an upwardly opened rectangular box shape the top opening of which is airtightly closed by a sealing plate 1B, as shown in FIG. 6. The exterior container 1A is formed by subjecting metal plate (e.g., aluminum or aluminum alloy) to deep drawing. The surface of the exterior container 1A has electrical conductivity. The battery cells 1 to be arranged side by side are formed in a thin rectangular box shape. The sealing plate 1B is also formed of a metal plate such as aluminum or aluminum alloy. The positive/negative electrode terminals 13 are secured to the both side parts of the sealing plate 1B. Terminal holders 14 are interposed between the terminals 13 and the sealing plate 1B.

(Terminal Holder 14)

The terminal holder 14 has a right triangular shape having a hypotenuse (inclined surface). The terminal holder 14 electronically insulates peripheral parts of the electrode terminal 13 except the protruding part of the electrode terminal 13, which protrudes from the upper surface of the battery cell 1. The terminal holder 14 is formed of electrically-insulating material such as plastic. The electrode terminal 13 is arranged in the inclined surface of the terminal holder 14. The electrode terminals 13 are arranged at predetermined positions in the both end parts of the battery cell 1 with protruding in the inclined orientation. The positive/negative electrode terminals 13 are connected to the positive/negative electrode plates (not shown) included in the battery cell.

(Bus Bar 11)

The electrode terminals 13 of the battery cells 1 are connected to each other by the bus bars 11. A fastening screw 13A is secured to the electrode terminal 13, and is inserted into the bus bar 11. A nut 12 is threadedly engaged with the fastening screw 13A. Thus, the bus bar 11 is fastened to the electrode terminal 13. The bus bar 11 is a metal plate which has through holes on the both end parts of the bus bar. The through holes receive the fastening screws 13A of the electrode terminals 13 of the battery cells 1 adjacent to each other. The bus bar 11 is fastened onto the electrode terminals 13. The bus bar 11 electrically connects the electrode terminals 13 of the adjacent battery cells 1 to each other. The connection pattern between the electrode terminals of the adjacent battery cells depends on serial connection or parallel connection. That is, in the case of serial connection, the positive terminal of one of the adjacent battery cells is connected to the negative terminal of the other of the adjacent battery cells. In the case of parallel connection, the positive and negative terminals of one of the adjacent battery cells are connected to the positive and negative terminals of the other of the adjacent battery cells, respectively. In the illustrated battery pack 10, the electrode terminals 13 of the adjacent battery cells 1 are serially connected to each other by the bus bars 11. In the case of the battery pack 10 in which the battery cells 1 are serially connected to each other, the output voltage of the battery pack can be high. Note that, in the battery pack 10 according to the present invention, battery cells adjacent to each other may be connected in parallel to each other so that the current capacity of the battery pack can be high.

(Separator 2)

The separator 2 is interposed between the battery cells 1 adjacent to each other, as shown in FIG. 6. Thus, the adjacent battery cell 1 is spaced at a predetermined interval away from each other, and is electrically insulated from each other. To achieve this, the separator 2 is formed of eclectically-insulating material. Thus, the separator 2 electrically insulates the exterior containers 1A of the adjacent battery cells 1 from each other. The separator 2 can be formed of electrically-insulating material such as plastic by molding. The separator 2 shown in FIG. 6 has the ventilation gaps 15, which are formed between the battery cells 1. Cooling gas such as air can flow through the ventilation gaps 4 to cool the battery cells 1. Thus, in the case where the separator 2 has the ventilation gaps 15, forcedly-blown cooling gas such as air passes through these ventilation gaps so that the battery cells 1 are cooled. Note that, the separator does not necessarily have the ventilation gaps. The reason is that, although not illustrated, the bottom surfaces of the battery cells can be thermally connected to a cooling plate which is forcedly cooled by coolant, or the like.

The separator 2 is integrally formed of plastic as a whole. As shown in FIGS. 5 and 6, the separator 2 has peripheral walls 22 that are arranged along the outer peripheral parts of the battery cells 1, and protrude in the battery cell 1 side-by-side arrangement direction. The peripheral walls 22 of the separator 2 have a substantially same inner shape as the exterior shape of the battery cell 1. According to this construction, when the battery cells 1 are held in the peripheral walls 22, the separator 2 can be arranged in place. The peripheral wall 22 includes vertical upper and bottom peripheral wall portions 22A, 22B and 22C. The vertical peripheral wall portion 22A is located outside each of the both side surfaces of the battery cell 1. The upper peripheral wall portion 22B is located outside the upper surface of the battery cell 1. The bottom peripheral wall portion 22C is located outside the bottom surface of the battery cell 1. The upper peripheral wall portion 22B at least partially covers the upper surface of the battery cell 1, and also serves as a cover portion 23. The upper peripheral wall portion 22B as the cover portion 23 has a shape which does not close the electrode terminal 13 and an opening 1C of a safety valve arranged on the upper surface of the battery cell 1 whereby exposing the opening 1C of the electrode terminal 13 or the safety valve. The bottom peripheral wall portion 22C is located on the bottom surface side of the separator 2, and protrudes in the side-by-side arrangement direction of the battery cell 1, i.e., in the horizontal direction.

The vertical peripheral wall portions 22A are located on the upper and lower side end parts of the separator 2. The vertical peripheral wall portion 22A arranged on the upper side end part of the separator 2 is coupled at a right angle to the upper peripheral wall portion 22B. The vertical peripheral wall portion 22A arranged on the lower side end part of the separator 2 is coupled at a right angle to the bottom peripheral wall portion 22C in the bottom surface side of the separator 2. The vertical peripheral wall portions 22A have a width that can cover the overall width of the both side surfaces of the battery cells 1 when the separators 2 are interposed between the battery cells 1. The protruding amount of the vertical peripheral wall 22A in the side-by-side arrangement direction of the battery cells 1 is half the thickness of the battery cell 1 so that vertical peripheral wall portions 22A can cover the overall width of the both side surfaces (i.e., the thickness) of the battery cells 1. The vertical peripheral wall portion is not continuously arranged from the upper side end to the lower side end of the separator 2, but the vertical peripheral wall portions 22A are arranged on the upper and lower side end parts of the separator. Thus, an opening 24 is formed between the upper and lower side end parts of the separator so that cooling air can be forcedly blown the space between the separator 2 and the battery cell 1.

The illustrated separator 2 includes protruding portions 25 that protrude from the side surfaces of the battery pack 10. In the illustrated separator 2, the protruding portions 25 are arranged on upper and lower both side ends and are formed integrally with the vertical peripheral wall portions 22A. The protruding portion 25 protrudes outward from the upper end part of the vertical peripheral wall portion 22A arranged on the upper side end part of the separator 2. The protruding portion 25 protrudes outward from the lower end part of the vertical peripheral wall portion 22A arranged on the lower side end part of the separator 2. As for the protruding portion 25 protruding outward from the vertical peripheral wall 22A, specifically, the protruding portion 25 is a protruding wall part that extends along the edge of the bind bar 4 to be arranged on the side surface of the battery pack 10. In the case where the separator 2 includes the protruding portions 25 arranged on the upper and lower vertical peripheral wall portions 22A, the protruding portions 25 contact the side edges of the bind bars 4 so that the vertical deviation of the separators 2 relative to the bind bar 4 can be prevented by this simple construction. In the illustrated separators 2, the lower edge of the bind bar 4 contacts the upper surface of the protruding portion 25 arranged on the lower vertical peripheral wall portion 22A. Thus, it is possible to prevent the upward deviation of the separator 2 relative to the bind bar 4. Also, in this separators 2, the upper edge of the bind bar 4 contacts the lower surface of the protruding portion 25 arranged on the upper vertical peripheral wall portion 22A. Thus, it is possible to prevent the downward deviation of the separator 2 relative to the bind bar 4. Although the illustrated separator 2 includes the protruding portions 25 on the upper and lower vertical peripheral wall portions 22A, the separator may include the protruding portion only one of the upper or lower vertical peripheral wall portion. The separator does not necessarily include the protruding portion. The protruding portion may be omitted.

(End Plate 3)

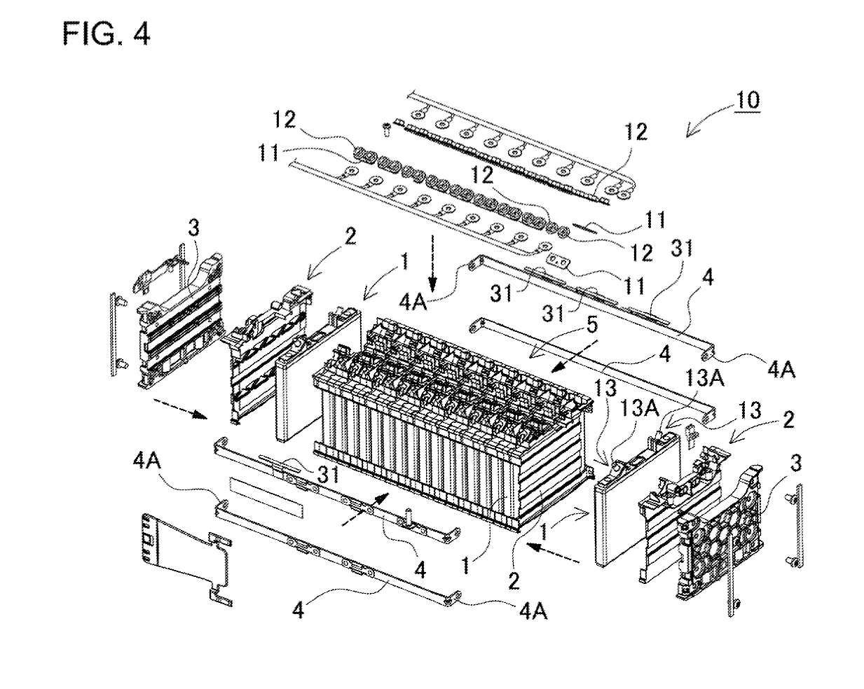

The battery assembly 5 is constructed of the plurality of battery cells 1 and electrically-insulating separators 2 which are alternately arranged side by side. As shown in FIG. 4, the battery assembly 5 is secured with the end plate 3 biasing the separators 2 located on the both end surfaces of the battery assembly 5. The end plate 3 is formed of hard plastic or metal such as aluminum or aluminum alloy. The end plate 3 has a substantially same exterior rectangular shape as the rectangular-box-shaped battery 1 so that the contact area of the end plate 3 with the battery cells 1 can be large. The rectangular end plate 3 has the same size as the battery cell 1, or a slightly larger size than the battery cell 1. In the case where the end plate is formed of plastic, the end plate 3 is directly fastened to the battery cell 1. In the case where the end plate is formed of metal, the end plate 3 is fastened to the battery cell 1 with an electrically insulating member being interposed between the end plate and battery cell. Thus, the battery assembly 5 including the battery cells 1 and the separators 2 is securely held from the side surfaces of the battery assembly 5 by the bind bars 4 with the battery assembly 5 being interposed between the end plates 3.

(Bind Bar 4)

As shown in FIGS. 3 to 6, the battery assembly 5 is securely held from the side surfaces of the battery assembly 5 by the bind bars 4. This bind bar 4 is a metal plate which extends in the side-by-side arrangement direction of the battery assembly 5, and has a predetermined width extending along the surface of the battery assembly 5. In the illustrated battery pack 10, two bind bars 4 are arranged spaced away from each other in the upper and lower parts of each of the side surfaces of the battery assembly 5 to securely hold the battery assembly 5. Thus, total four bind bars 4 securely hold the battery assembly 5 from the left and right side surfaces. In addition, both the end parts of the bind bar 4 are bent at a roughly right angle so as to match the exterior side surfaces of the end plates 3, and serve as bent portions 4A. A through hole is arranged in the bent portion 4A. A bolt 17 is inserted into the through hole and is threadedly engaged with the end plate 3 so that the bind bar 4 is fastened to the end plate 3.

(Regulation Member 31)

The battery pack 10 shown in FIGS. 3 to 5 includes a regulation member 31 that, when the battery pack is secured onto a horizontal surface, regulates upward deviation of some of battery cells 1 which are located in a central part of the battery pack in the side-by-side arrangement direction of the battery cells 1. The illustrated regulation member 31 is a biasing member which is opposed to the some of the battery cells 1, which is located in the central part, and contacts the upper surface of the battery pack 10. The regulation member 31 as the biasing member biases the battery pack 10 from the upper surface side whereby preventing upward deviation of the central battery cells 1.

The biasing member 31 shown in FIGS. 5, 7 and 8 is a bracket 33 which is secured to the bind bar 4. The lower end part as an attachment portion 33B of the illustrated bracket 33 is secured to the bind bar 4. The bracket 33 has a horizontal portion 33A extending along the upper surface of the battery pack 10. The horizontal portion 33A contacts the upper surface of the battery pack 10. The thus-constructed bracket 33 can be formed by bending a metal plate. Note that the bracket may be formed of hard plastic. In the illustrated bracket 33, the attachment portion 33B is secured to the upper bind bar 4, which is located on the upper side, of the two bind bars 4, which are arranged spaced away from each other in the vertical direction. The attachment portion 33B is arranged at a predetermined position of the bind bar 4. In the case where the bracket 33 is thus secured to the upper bind bar 4, the horizontal portion 33A of the bracket 33 can be most simply arranged at a predetermined position of the upper surface of the battery pack 10. Note that the bracket may be secured to the lower bind bar. The metal bracket 33 can be secured to the bind bar 4 by welding. Note that the bracket may be secured to the bind bar by a coupling member such as bolt and nut structure. In this coupling structure, the bracket can be detachably fastened to the bind bar. Also, the bracket as the regulation member is not limited to a separated component which is constructed separately from the bind bar and is then secured to the bind bar. The bracket as the regulation member can be formed integrally with the bind bar.

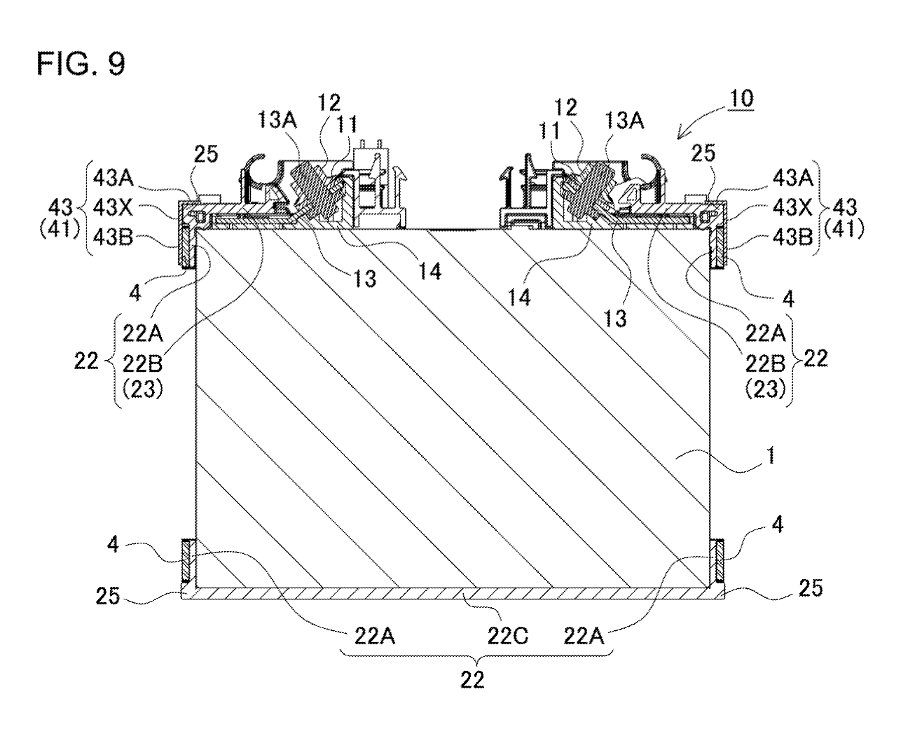

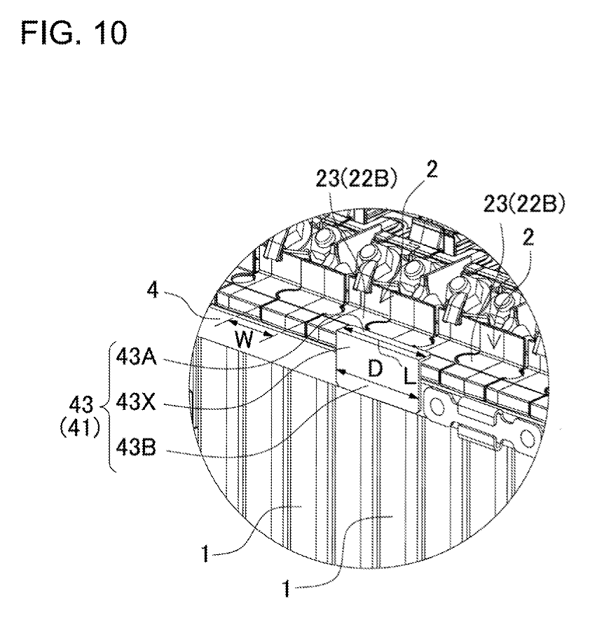

The illustrated bracket 33 has a rectangular U-shaped cross-sectional shape so that an insertion recessed portion 33C is formed between the attachment portion 33B and the horizontal portion 33A. The insertion recessed portion 33C guides the protruding portion 25 of the separator 2. In the thus-constructed blanket 33, even in the case where the protruding amount of the protruding portion 25 is large which is arranged in the separator 2, the horizontal portion 33A of the bracket 33 can surely contact the upper surface of the battery pack 10. Note that, as shown in FIG. 9 and FIG. 10, a regulation member 41 as the biasing member can have a bracket 43 which has an inverted L-shaped cross-sectional shape. In this regulation member, the bracket 43 includes a horizontal portion 43A, and a vertical portion 43X. The horizontal portion 43A extends from the upper end of the vertical portion 43X along the upper surface of the battery pack 10. The horizontal portion 43A contacts the upper surface of the battery pack 10. The lower end part of the vertical portion 43X can serve as an attachment portion 43B. The attachment portion 43B is secured to the bind bar 4. This bracket 43 can be most simply manufactured by bending a metal plate. The thus-constructed bracket can be suitably used for a separator which includes a protruding portion with a small protruding amount, or a separator without the protruding portion.

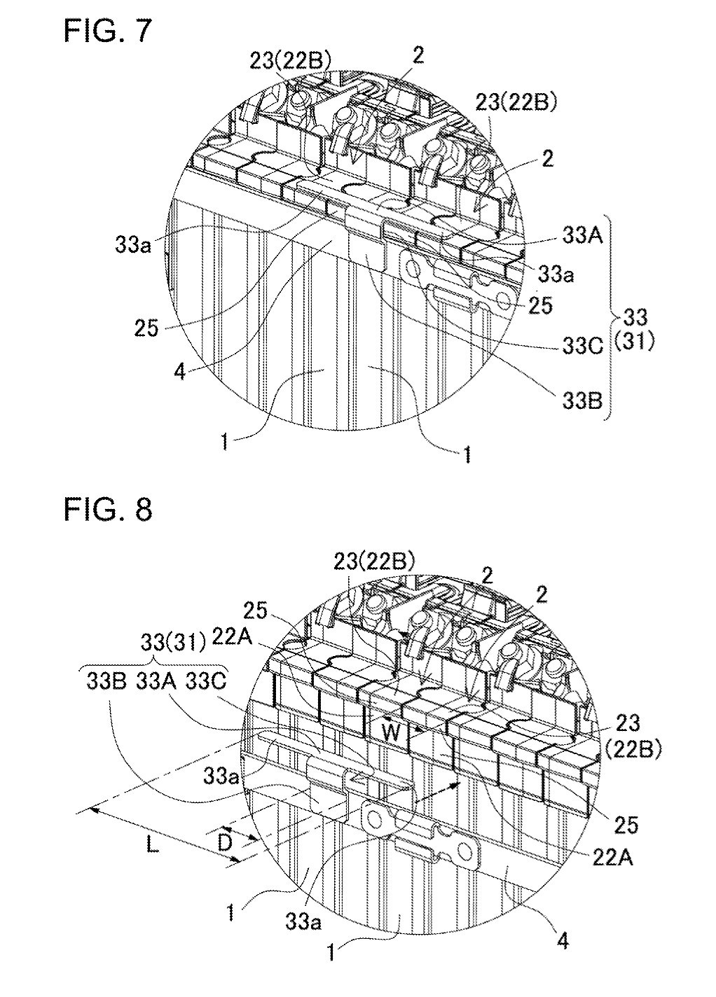

In the bracket 33 shown in FIGS. 7 and 8, the horizontal portion 33A includes an extending portion 33a which extends in the side-by-side arrangement direction of the battery cells 1. According to this bracket 33, since the horizontal portion 33A can have a long overall length (L) in the side-by-side arrangement direction of the battery cells 1, the horizontal portion 33A can contact a wide area of upper surface of the battery pack 10. In particular, although the holding portion 33B secured to the bind bar 4 can have a narrow width (D), the overall length (L) of the horizontal portion 33A can be long so that this long horizontal portion can contact the upper surfaces of two or more of the separators 2. In the illustrated bracket 33, the horizontal portion 33A including the extending portion 33a has an overall length (L) that allows the horizontal portion 33A to contact the upper surfaces of two or more of the separators 2. In the illustrated bracket 33, the width (D) of the holding portion 33B is substantially equal to the width (W) of the separator 2, while the overall length (L) of the horizontal portion 33A including the extending portion 33a is about 3 times the width (W) of the separator 2. According to this bracket 33, the horizontal portion 33A including the extending portion 33a contacts the upper surfaces of three or four of the separators 2. Therefore, it is possible to effectively prevent upward deviation of battery cells 1 that are opposed to the horizontal portion. Note that, in the bracket, the width (D) of the holding portion can be 0.5 to 2 times the width (W) of the separator 2, while the overall length (L) of the horizontal portion including the extending portion can be 2 to 5 times the width (W) of the separator 2.

Although, in the thus-constructed bracket 33, the horizontal portion 33A includes the extending portion 33a whereby increasing the overall length (L) of the horizontal portion, the horizontal portion of the bracket does not necessarily include the extending portion. The overall length (L) of the horizontal portion 43A may be equal to the width (D) of the holding portion 43B, as shown in FIG. 10. However, even in the case where the bracket 43 includes the horizontal portion 43A without the extending portion, the horizontal portion preferably contact the upper surfaces of two or more separators 2. In the bracket 43 shown in FIG. 10, the overall length (L) of the horizontal portion 43A is larger than the width (W) of the separator 2 so that the horizontal portion 43A contacts three separators 2 adjacent to each other. This bracket 43 can also prevent upward deviation of two or more battery cells 1 which are opposed to the horizontal portion 43A. In this bracket, the overall length (L) of the horizontal portion can be 1 to 3 times the width (W) of the separator, preferably 1.2 to 2 times the width (W) of the separator, for example, so that the horizontal portion can contact the upper surfaces of two or more separators.

A plurality of thus-constructed regulation members 31 can be arranged in the bind bar 4. According to the bind bar 4 that includes a plurality of regulation members 31, two or more battery cells 1 which are located in the central part can be held at a plurality positions. Therefore, it is possible to surely prevent deviation of the two or more battery cells 1. In particular, among battery cells 1 which are located in the central part, two or more battery cells 1 can be selectively held which are likely to be deviated upward. The numbers of regulation members can be different from each other which are included in the bind bars 4, which are located on the side surfaces of the battery pack 10. In the power supply device shown in FIG. 2, the battery packs 10 are arranged in two rows. One regulation member 31 is arranged in the bind bar 4 that is located on the central side which is located between the battery packs 10 in the two rows. Three regulation members 31 are arranged in the bind bar 4 that is located on the outside. The number of the regulation member 31 secured to the bind bar 4 can be varied depending on arrangement and available space.

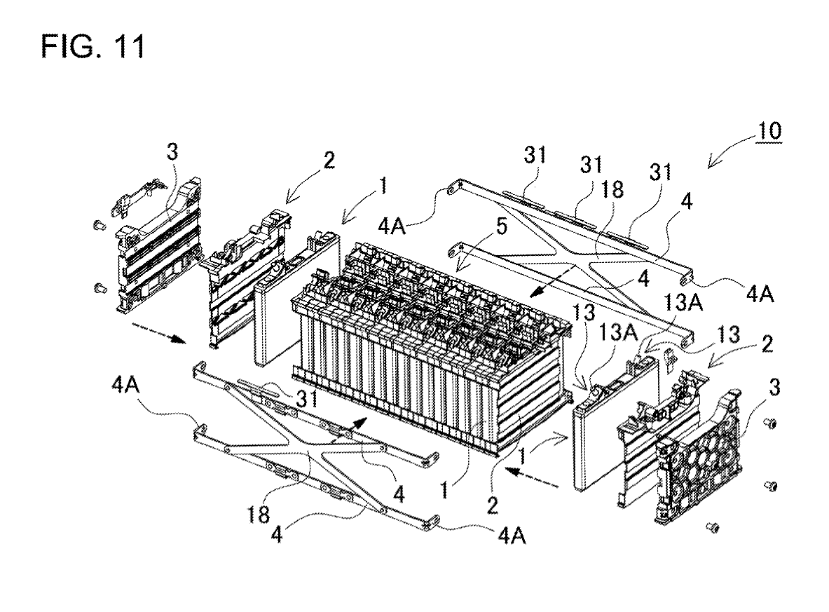

In a battery pack 10 shown in FIG. 11, the central parts of the upper and lower bind bars 4 are coupled to each other by a reinforcement plate 18. In the illustrated battery pack 10, the upper and lower bind bars 4 are coupled to each other by the reinforcement plate 18, which includes intersecting parts. The intersecting parts intersect with and are secured to the bind bars 4. Thus, the bind bars can be reinforced. The illustrated reinforcement plate 18 is a metal plate extending along the side surface of the battery pack 10, and is secured to the bind bars 4 by welding, or the like. In this battery pack 10, since the upper and lower bind bars 4 are coupled to each other by the reinforcement plate 18, it is possible to provide a strong structure which prevents relative deviation and deformation of the bind bars 4, and additionally to hold battery cells 1 that are arranged side by side in the central part by the bracket 33 secured to the upper bind bar 4 with battery cells being less likely to vibrate.

The reinforcement plate is not limited to the aforementioned shape. The reinforcement plate can be one or a plurality of plates which can the upper and lower bind bars to each other. The reinforcement member, which couples the upper and lower bind bars to each other, may be arranged extending downward and secured to the base plate.

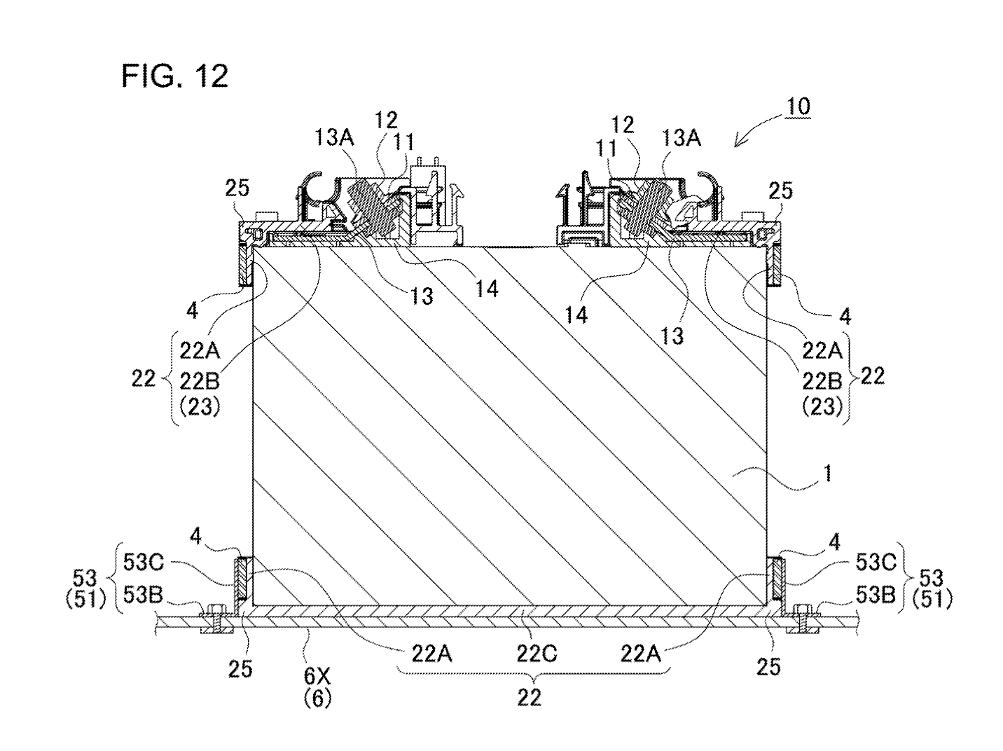

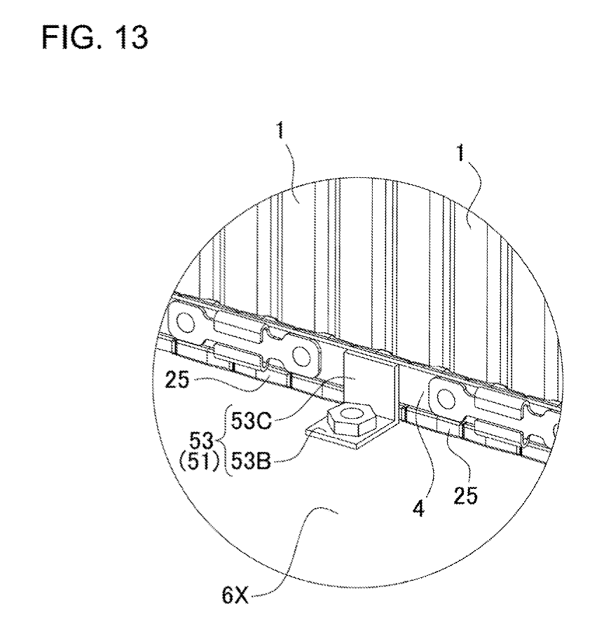

The regulation member 51 shown in FIGS. 12 and 13 is a securing member 53 which secures the bind bar 4 to the base plate 6X. A regulation member 51 as the securing member 53 secures the bind bar 4 to the base plate 6X where by preventing upward deviation of the central battery cells 1. The securing member 53 shown in FIGS. 12 and 13 has an L-shape in cross-section. A vertical part of the securing member 53 as a holding portion 53C is secured to the bind bar 4. A bent part of the securing member 53 as a coupling portion 53B is secured to the base plate 6X. The thus-constructed securing member 53 can be formed by bending a metal plate. Note that the securing member may be formed of hard plastic. The metal securing member 53 can be secured to the bind bar 4 by welding holding portion 53C to the bind bar 4. Note that the securing member may be secured to the bind bar by a coupling member such as bolt and nut structure. In this coupling structure, the securing member can be detachably fastened to the bind bar. In addition, the coupling portion 53B is threadedly engaged with and secured to the base plate 6X. In the illustrated securing member 53 is secured to the upper bind bar 4, which is located on the upper side, of the two bind bars 4, which are arranged spaced away from each other in the vertical direction. In this construction, when the lower bind bar 4 is secured to the base plate 6X, the protruding portions 25 of the separators 2 arranged along the lower edge of the bind bar 4 are sandwiched between the bind bar 4 and the base plate 6X so that the lower surfaces of the separators 2 are secured to the upper surface of the base plate 6X. Note that the securing member can be secured to both the upper and lower bind bars.

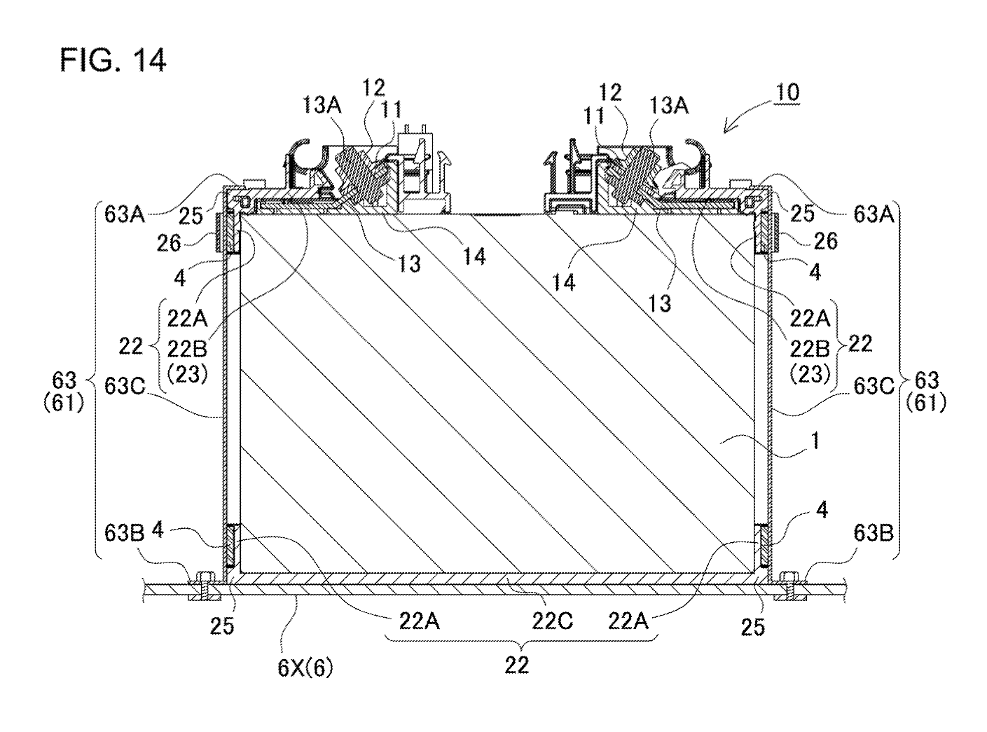

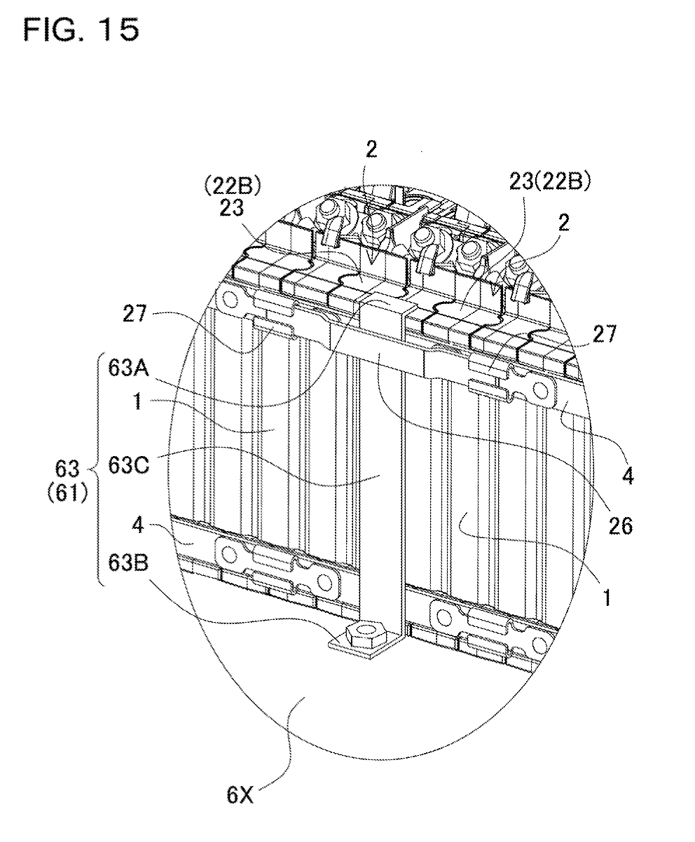

A regulation member 61 shown in FIGS. 14 and 15 is a securing member 63 which secures the central part of the battery pack 10 to the base plate 6X. One end of the securing member 63 is secured to the base plate 6X, while the other end contacts the upper surface of the battery pack 10. Thus, upward deviation of the central battery cells 1 can be prevented. The upper and lower end parts of the securing member 63 are bent in opposite directions. The lower bent portion as a coupling portion 63B is secured to the base plate 6X. The upper bent portion as a horizontal portion 63A contacts the upper surface of the battery pack 10. The horizontal portion 63A extends along the upper surface of the battery pack 10. The coupling portion 63B of the illustrated securing member 63 is threadedly engaged with and secured to the base plate 6X. The thus-constructed securing member 63 can be formed by bending a metal plate. Note that the securing member may be formed of hard plastic. The central part of the illustrated securing member 63 as a vertical portion 63C is coupled to the upper and lower bind bars 4. In the illustrated securing member 63, the lower part of the vertical portion 63C is secured to the lower bind bar 4 by welding, while the upper part of the vertical portion 63C is coupled to the upper bind bar 4 by a coupling member 26. The illustrated coupling member 26 is a coupling bar which forms an insertion gap between the coupling member 26 and the bind bar 4. The both ends of the coupling bar are inserted in insertion coupling portions 27 constructed on the bind bar 4 so that the coupling bar is secured at a predetermined position. Note that the upper and lower parts of the vertical portion of the securing member may be secured to the bind bar by welding. Also, the upper and lower parts of the vertical portion may be coupled to the bind bar by the coupling member. Also, the securing member may be secured to the bind bar by a coupling member such as bolt and nut structure. Also, the securing member may include the extending portion arranged in the horizontal portion similar to the bracket 33 shown in FIGS. 7 and 8.

A plurality of regulation members as the securing members can be arranged on the side surface of the battery pack. In the case where the battery pack includes a plurality of securing members on the side surface, the lower surfaces of the plurality of separators arranged in the central part are secured to the upper surface of the base plate so that upward deviation of the central battery cells can be surely prevented. The numbers of securing members can be different from each other which are arranged on the both side surfaces of the battery pack. The number of the securing members arranged on the side surfaces of the battery pack can be varied depending on arrangement and available space.

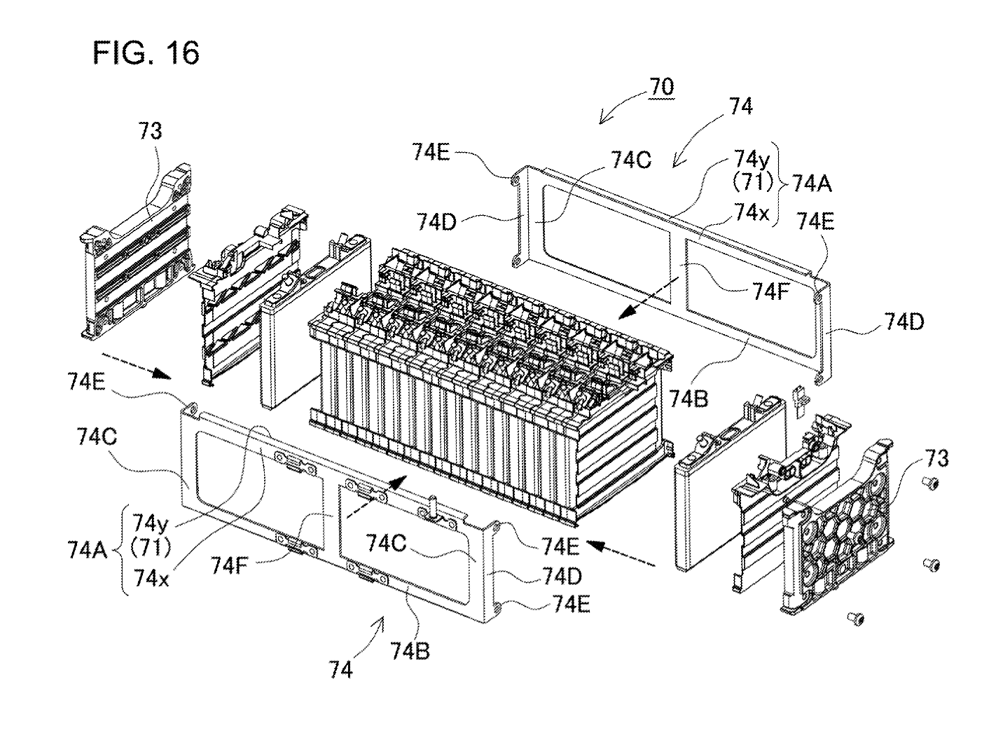

In the aforementioned battery pack 10, two bind bars are attached onto each of the both side surfaces of the battery assembly 5. The both ends of each bind bar are secured onto the end plates 3. Note that the battery pack can include an integral structure of integrally-constructed upper and lower bind bars, as shown in FIG. 16. In the illustrated bind bar 74, coupling portions 74C couple the ends of an upper bar portion 74A to the ends of a lower bar portion 74B, which are arranged on the upper and lower end parts of the side surface of the battery assembly 5. The coupling portions 74C are secured to the end plates 73. The coupling portions 74C of the bind bar 74 are bent inward so as to fit the shape of a part from the peripheral surface to the main surface of the end plate 73. Each of thus-formed bent portions 74D includes holding portions 74E, which are arranged on the upper and lower parts and are secured onto each of the end plates 73. The bind bar 74 can be manufactured by cutting and then stamping a metal plate of iron or iron alloy. In addition, the illustrated bind bar 74 includes a horizontal portion 74y which is formed by bending the upper end part of the upper bar portion 74A inward and extends along the upper surface of the battery pack 70. In the illustrated bind bar 74, the upper bar portion 74A has an inverted L-shape in cross section. Thus, the horizontal portion 74y is coupled to the vertical portion 74x.

In the bind bar 74 shown in FIG. 16, the horizontal portion 74y is arranged on the upper edge of the upper bar 74A and serves as a regulation member 71. This regulation member 71 contacts the upper surface of the battery pack 70 so that upward deviation of the central battery cells 1 can be prevented. In the illustrated bind bar 74, the horizontal portion 74y is arranged opposed to battery cells 1 that are located in the central part, in other words, battery cells 1 except battery cells 1 which are located on both ends, among the plurality of battery cells 1 arranged side by side adjacent to each other. Accordingly, this bind bar 74 can effectively prevent upward deviation of all of central battery cells 1. Note that the bind bar may have horizontal portions which are opposed to all of the battery cells arranged side by side adjacent to each other whereby preventing upward deviation of all of the central battery cells 1 which compose the battery assembly. As discussed above, in the case where the bind bar 74 includes the horizontal portion 74y extending along the longitudinal direction, since the horizontal portion 74y can reinforce the vertical portion 74, it is possible to improve the vertical and horizontal bending strength of the bind bar 74. Therefore, the battery assembly 5 can be more firmly held. Note that the bind bar may include one or a plurality of horizontal portions which are opposed to some of battery cells located in the central part so that upward deviation of the some of the central battery cells can be prevented.

The bind bar 74 shown in FIG. 16 includes a coupling reinforcement portion 74F, which couples the central parts of the upper and lower bar portions 74A and 74B opposed to each other. Thus, the bind bar 74 is reinforced. According to this construction, it is possible to improve the stiffness of the bind bar 74. In the illustrated bind bar 74, although one coupling reinforcement portion 74F couples the central parts of the upper and lower bar portions 74A and 74B to each other, the central parts of the upper and lower bar portions may be coupled to each other by a plurality of coupling reinforcement portions.

Although the bind bar 74 shown in FIG. 16 includes the bind bar portions arranged in the upper and lower parts and are formed integrally with each other, and the horizontal portion 74y arranged on the upper bar portion 74A located in the upper part, the upper and lower bind bar portions of the bind bar are not necessarily formed integrally with each other so that the upper and lower bind bar portions are spaced in the vertical direction away from each other. In this case, the upper end part of the bind bar portion located in the upper part can be bent inward so that the horizontal portion can be formed extending along the upper surface of the battery pack and serve as the regulation member. The horizontal portion of this bind bar contacts the upper surface of the battery pack so that upward deviation of two or more of the central battery cells can be effectively prevented. A reinforcement member can couple the lower bind bar portion to the upper bind bar portion, which includes the horizontal portion formed by bending the upper end part of the upper bind bar portion inward. Alternatively, the upper bind bar portion can be coupled to the base plate by a securing member. According to this construction, it is possible to more surely prevent vibration of battery cells which are arranged side by side in the central part.

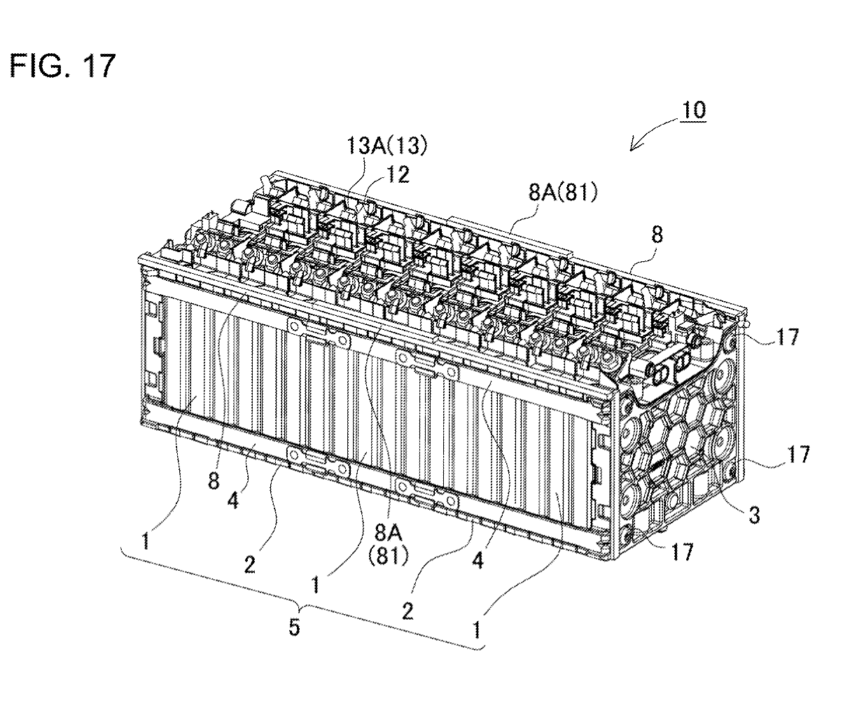

A battery pack 10 shown in FIG. 17 includes a sealing member 8 is sandwiched between the top covers 6A and the battery pack 10. The top cover 6A covers the upper surface of battery pack. The central part of the sealing member 8 as a thicker portion 8A is thicker than the other parts of the sealing member. This thicker portion 8A serves as a regulation member 81. When the sealing member is pressed by the top case 6A to seal the gap between the top case 6A and the battery pack 10 as shown in FIG. 1, since the central part of the sealing member 8 is thicker than other parts of the sealing member, the central part of the battery pack 10 is more strongly biased from the upper surface side. According to this construction, it is possible to effectively prevent upward deviation of battery cells which are located in the central part of the battery pack 10. This sealing member 8 is preferably formed of a urethane seal. The reason is that, in the case where the sealing member 8 is formed of urethane, the sealing member has excellent durability under high temperature environments and excellent elasticity for a long time. Note that the sealing member may be formed of any, sealing materials other than urethane.

In the sealing member 8 shown in FIG. 17, sealing member sheets are overlaid in the central part of the sealing member so that the thicker portion 8A is formed thicker than other parts of the sealing member. According to this construction, the thicker portion 8A can be most simply formed in the central part of the sealing member 8. Note that the sealing member may be formed more thickly in the central part than the other parts by molding so that the thicker portion is constructed. The thickness of the thicker portion 8A of the sealing member 8 is 1.2 to 3 times the thickness of other parts, preferably 1.5 to 2.5 times the thickness of other parts. In this range, the central part of the battery pack 10 can be ideally biased.

(Exterior Case 6)

As shown in FIGS. 1 and 2, the aforementioned battery packs 10 are accommodated in the exterior case 6. Thus, the power supply device is constructed. The exterior case 6 shown in FIG. 1 includes the base plate 6X which is located under the lower surface of the battery pack 10, and the cover plate 6Y which is secured onto the base plate 6X. The cover plate 6Y is composed of the top cover 6A, and the electronic-component cover 6B. The base plate 6X, the top cover 6A, and the electronic-component cover 6B are stiff metal plates which can bear the weight of the battery block 2 to be accommodate in the exterior case. The base plate 6X, the top cover 6A, and the electronic-component cover 6B are manufactured by stamping metal plates.

The base plate 6X, and the top cover 6A are formed in U shapes in cross section by stamping metal plates. The electronic-component cover 6B is formed in an L shape in cross section by stamping a metal plate. The base plate 6X and the top cover 6A have side wall portions 6X and 6a on the both sides, respectively. The electronic-component cover 6B has a side wall portion 6b on one side. In the exterior case 6 shown in FIG. 1, the width of the base plate 6X is larger than the top cover 6A. Thus, the electronic-component accommodating portion 29 is formed between the side wall portion 6X of the base plate 6X, and the side wall portion 6a of the top cover 6A. The opening of the electronic-component accommodating portion is closed by the electronic-component cover 6B. The width of the base plate 6X is increased from the width of the top cover 6A by a width corresponding to the width of the electronic-component accommodating portion 29. That is, the width of the base plate 6X can be obtained by adding the width of the electronic-component accommodating portion 29 to the width of the top cover 6A.

One (right side in FIG. 1) of the side wall portions 6X of the base plate 6X is securely coupled to one of the side wall portions 6a of the top cover 6A. The left side wall portion 6a of the top cover 6A is secured to the bottom of the base plate 6X to partition space inside the exterior case into the battery accommodating portion 28 for accommodating the battery pack 10 and the electronic-component accommodating portion 29. The vertical length of the left side wall portion 6a of the top cover 6A to be secured to the bottom of the base plate is larger than the right side wall portion 6a. Thus, the lower rim of the right side wall portion can be secured to the bottom of the base plate 6X. Coupling portions are formed on the rims of the base plate 6X and the top cover 6A to be coupled to each other. The coupling portions are formed by bending the lower end parts of the base plate or the top cover, and have a predetermined width. The coupling portions are secured to each other with one being placed on another so that the base plate 6X and the top cover 6A are coupled to each other. Another (left side in FIG. 1) of the side wall portions 6X of the base plate 6X is securely coupled to the side wall portion 6b of the electronic-component cover 6B, which is secured to the top cover 6A.

The electronic-component cover 6B is placed on and secured to one side part of the upper surface of the top cover 6A. The electronic-component cover 6B includes a top plate, and the side wall portion 6b extending from one side of the top plate. The electronic-component cover 6B can be constructed by forming a metal plate into an L shape. The end of the top plate of the electronic-component cover 6B is placed on and secured to the top end of the top cover 6A. The bent coupling portion formed on the lower end of the side wall portion 6b is secured to the bent coupling portion arranged on the upper end of the left side wall portion 6X of the base plate 6X. In the thus-constructed exterior case 6, the side wall portion 6a arranged on the left side of the top cover 6A in FIG. 1 partitions space inside the top cover into the battery accommodating portion 28 and the electronic-component accommodating portion 29.

In the power supply device shown in FIG. 2, the battery packs 2 are secured in columns and rows inside the exterior case 6. In the illustrated power supply device 6, two battery packs 2 are arranged in straight in each column on the base plate 6X. Two sets of the two battery packs 2 are arranged in two rows. Thus, four battery packs 10 are accommodated in the exterior case. Note that the power supply device can be composed of one or a plurality of battery packs which are arranged in a single column. The power supply device does not necessarily include the electronic-component accommodating portion. Only the battery packs may be accommodated in the exterior case.

The aforementioned battery packs can be used as a power supply device for vehicles. The power supply device can be installed on electric vehicles such as hybrid cars that are driven by both an engine and a motor, and electric vehicles that are driven only by a motor. The power supply device can be used as a power supply device for these types of vehicles.

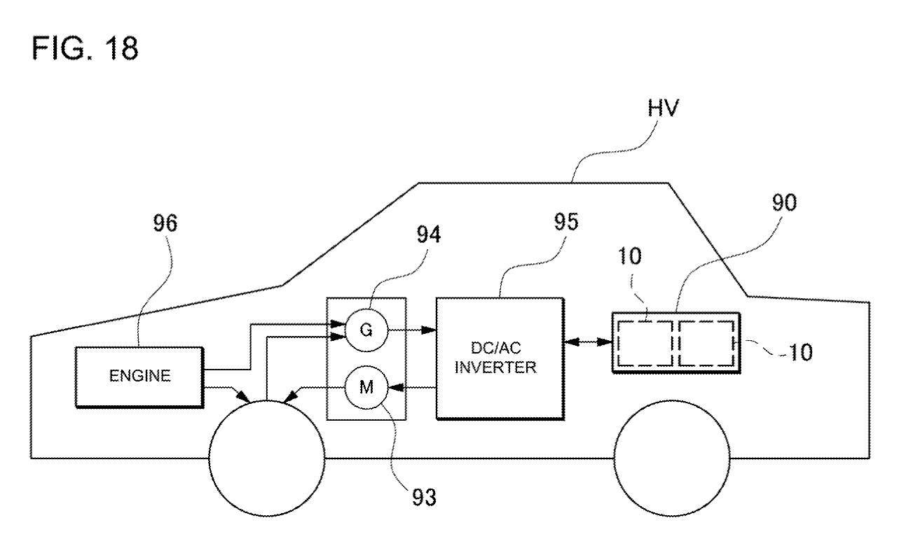

FIG. 18 is a block diagram showing an exemplary hybrid car that is driven both by an engine and an electric motor, and includes the power supply device. The illustrated vehicle HV with the power supply device includes an electric motor 93 and an engine 96 that drive the vehicle HV, a power supply device 90 that includes the battery packs 10 and supplies electric power to the electric motor 93, and an electric generator 94 that charges batteries of the battery packs 10. The power supply device 90 is connected to the electric motor 93 and the electric generator 94 via a DC/AC inverter 95. The vehicle HV is driven both by the electric motor 93 and the engine 96 with the batteries of the power supply device 90 being charged/discharged. The electric motor 93 is energized and drives the vehicle in a poor engine efficiency range, e.g., in acceleration or in a low speed range. The electric motor 93 is energized by electric power that is supplied from the power supply device 90. The electric generator 94 is driven by the engine 96 or by regenerative braking when users brake the vehicle so that the batteries of the power supply device 90 are charged.

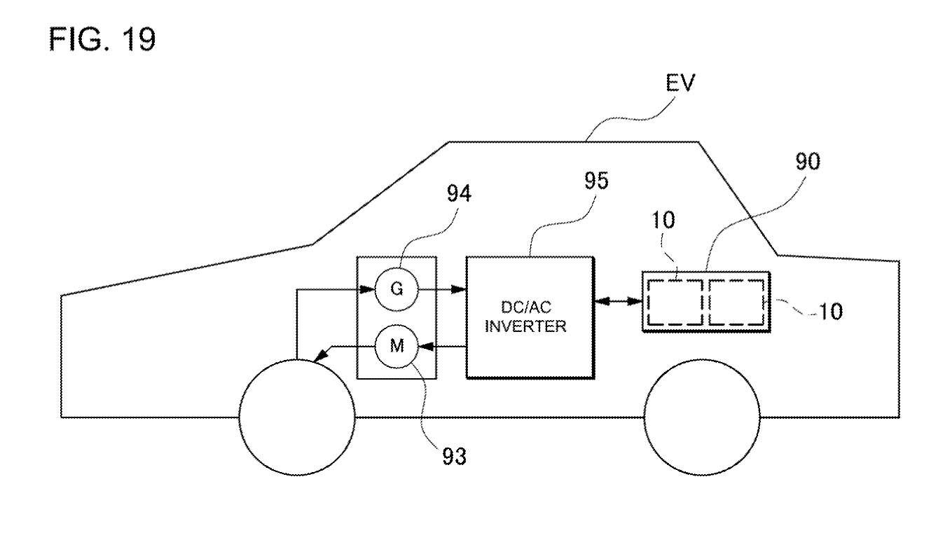

FIG. 19 shows an exemplary electric vehicle that is driven only by an electric motor, and includes the power supply device. The illustrated vehicle EV with the power supply device includes an electric motor 93 that drives the vehicle EV, a power supply device 90 that includes the battery packs 10 and supplies electric power to the electric motor 93, and an electric generator 94 that charges batteries of the battery packs 10. The power supply device 90 is connected to the electric motor 93 and the electric generator 94 via a DC/AC inverter 95. The electric motor 93 is energized by electric power that is supplied from the power supply device 90. The electric generator 94 can be driven by vehicle EV regenerative braking so that the batteries of the power supply device 90 are charged.

### INDUSTRIAL APPLICABILITY

A battery pack according to the present invention can be suitably used as vehicle power source for electric vehicles or hybrid cars. An electrically-driven vehicle including this battery pack according to the present invention can be suitably used as electric vehicles or hybrid cars. Also, a battery pack according to the present invention can be suitably used as power supply devices for applications other than vehicle power supply device.

It should be apparent to those with an ordinary skill in the art that while various preferred embodiments of the invention have been shown and described, it is contemplated that the invention is not limited to the particular embodiments disclosed, which are deemed to be merely illustrative of the inventive concepts and should not be interpreted as limiting the scope of the invention, and which are suitable for all modifications and changes falling within the scope of the invention as defined in the appended claims. The present application is based on Application No. 2010-270,978 filed in Japan on Dec. 4, 2010, the content of which is incorporated herein by reference.

What is claimed is:

1. A battery pack comprising:
a plurality of battery cells that have a rectangular box exterior shape;
a bind bar that couples said plurality of battery cells to each other with the battery cells being arranged side by side; and
a regulation member that, when said battery pack is secured onto a horizontal surface, regulates upward deviation of at least one of the battery cells, which is located in a central part of said battery pack in the side-by-side arrangement direction of said battery cells.

2. The battery pack according to claim 1, wherein said regulation member is a biasing member which is opposed to the at least one battery cell, which is located in the central part, and contacts the upper surface of the battery pack.

3. The battery pack according to claim 2, wherein said regulation member is a bracket which is secured to said bind bar and has a horizontal portion extending along the upper surface of said battery pack, wherein the horizontal portion contacts the upper surface of the battery pack.

4. The battery pack according to claim 1, wherein said bind bar includes a plurality of regulation members as said regulation member.

5. The battery pack according to claim 4, wherein bind bars as said bind bar are arranged on the both side surfaces of said battery pack, wherein the numbers of said plurality of regulation members are different from each other which are included in the bind bars, which are located on the side surfaces.

6. The battery pack according to claim 1, wherein said bind bar is arranged on a side surface of said battery pack, wherein the upper end part of said bind bar is bent so that a horizontal portion is formed extending along the upper surface of said battery pack, wherein this horizontal portion serves as said regulation member to contact the upper surface of the battery pack.

7. The battery pack according to claim 1 further comprising
a top cover that covers the upper surface of said battery pack, and
a sealing member that is sandwiched between said top cover and the battery pack, wherein
said regulation member is a thicker portion of said sealing member that is located in the central part and formed thicker than other parts of said sealing member.

8. The battery pack according to claim 7, wherein said thicker portion is formed of a urethane sheet.

9. The battery pack according to claim 1 further comprising a plurality of electrically-insulating separators that are interposed between said battery cells adjacent to each other, wherein said separators cover at least parts of upper surfaces of said battery cells and also serve as cover portions, wherein said regulation member contacts the upper surfaces of said cover portions.

10. The battery pack according to claim 1 further comprising a base plate that is located under the lower surface of said battery pack, said battery pack being secured onto this base plate, wherein said regulation member is a securing member that fastens said bind bar to the base plate.

11. The battery pack according to claim 1 further comprising a base plate that is located under the lower surface of said battery pack, said battery pack being secured onto this base plate, wherein said regulation member is a securing member that fastens the central part of said battery pack to the base plate, wherein the lower end part of said securing member is secured to the base plate, and said securing member has a horizontal portion on the upper end extending along the upper surface of said battery pack, wherein the horizontal portion contacts the upper surface of the battery pack.

12. The battery pack according to claim 1 further comprising a plurality of electrically-insulating separators that are interposed between said battery cells adjacent to each other, wherein said separator includes protruding portions that protrude outward from the both side surfaces of said battery pack, wherein the protruding portions are arranged extending along the side edges of said bind bar so that said protruding portion suppresses vertical deviation of the separator relative to the bind bar.

13. The battery pack according to claim 1, wherein bind bars as said bind bar are arranged on a side surface of said battery pack, and are spaced away from each other in the vertical direction.

14. The battery pack according to claim 13, wherein the central parts of said upper and lower bind bars are coupled to each other by a reinforcing member.

15. An electrically-driven vehicle comprising the battery pack according to claim 1.
